(19) United States
(12) Patent Application Publication
(10) Pub. No.: US 2015/0360828 A1
(43) Pub. Date: Dec. 17, 2015

(54) REINFORCED FOIL MEMBRANE

(71) Applicant: American Packaging Corporation, Columbus, WI (US)

(72) Inventors: James W. Forster, Haydenville, MA (US); Seth G. Holmen, Ames, IA (US)

(73) Assignee: American Packaging Corporation, Columbus, WI (US)

(21) Appl. No.: 14/737,980

(22) Filed: Jun. 12, 2015

Related U.S. Application Data
(60) Provisional application No. 62/011,630, filed on Jun. 13, 2014.

(51) Int. Cl. B65D 43/02; B32B 15/20; B32B 27/36; B32B 15/09

(52) U.S. Cl. CPC B65D 43/0233; B32B 15/09; B32B 15/20; B32B 27/36; B32B 2255/10; B32B 2255/26; B32B 2307/31; B32B 2307/5825; B32B 2307/581; B32B 2439/70; B32B 2309/105

(57) ABSTRACT

A lidding material and a container using such material, where the lidding material includes a sealant layer, a biaxially-oriented film, and a thin metallic foil layer having a thickness not greater than about 0.0005-0.0007 inches, where the thin metallic foil layer is adhered to one side of the biaxially-oriented film, and the sealant layer is applied to an opposite side of the biaxially-oriented film.

This application claims priority under 35 U.S.C. §119 to U.S. Provisional Patent Application No. 62/011,630 for a REINFORCED FOIL MEMBRANE, filed Jun. 13, 2014 by James W. Forester, which is hereby incorporated by reference in its entirety.

A laminated biaxially-oriented film is provided with foil and sealant layers to produce an improved lidding material for use on containers with peel-away lids.

### BACKGROUND AND SUMMARY

Foil membranes are used as lidding material on containers of products such as yogurt, fruit juice cups, applesauce, condiments, cream cheese, etc. Generally, foil membrane consists of aluminum foil (0.0013 in.-0.002 in.) thick, that is either coated with polymer (0.001 in.-0.00125 in. thick) or laminated to a polyolefin film (0.001 in.-0.0015 in. thick). The foil provides a nearly impermeable barrier to gases, helping to preserve the contents, while the polymer, when heated, seals to the container. The polymer sealant is engineered to provide either a permanent bond to the container or a “peelable” seal to allow easy access to the package contents.

Current practice utilizes foil of a thickness that is greater than what is necessary to achieve the requisite barrier to gas permeation. Efforts to reduce the foil thickness, however, have resulted in lidding materials and individual lids that have excessive curl, or that puncture too easily during handling and shipping, or that tear when the consumer is opening the package.

The embodiments disclosed herein also address a need for improved puncture resistance in lidding materials. More particularly, even with significant foil thicknesses there is still a propensity for the lidding to puncture or tear given various downward forces (from different devices) and/or from pulling the lidding off from the container. However, the disclosed inclusion of biaxially-oriented film largely eliminates these issues. In other words, the addition of a biaxially-oriented material layer results in a lidding film having greater resistance to a range of downward and/or pull forces exerted on the lidding while preventing a puncture or tear. The lamination of the biaxially-oriented film with the foil also allows for the use of a much thinner foil layer to achieve a desired impermeable barrier for a lid.

The foil membrane is supplied to the packaging equipment as rolls or as individual lids. It is important in both configurations, although more critical in the latter, that the membrane material does not have a tendency to curl after the lid is cut to size. Also critical in the latter configuration is that each individual lid can be dispensed singly from a stack of pre-cut lids. Generally, the outer surface of the foil lid is embossed with a pattern that reduces the surface contact with the sealant side of the adjacent lid, facilitating separation.

Disclosed in embodiments herein is a lidding material, comprising: a sealant layer; a biaxially-oriented film; and a thin metallic foil layer having a thickness not greater than about 0.0007 inches and preferably equal to or less than about 0.0005 inches, where the thin metallic foil layer is adhered to one side of the biaxially-oriented film, and the sealant layer is applied to an opposite side of the biaxially-oriented film.

Further disclosed in embodiments herein is a container comprising: a lower portion having a recess therein and forming an opening; and a lid, precut from a sheet and continuously sealed to the container around the opening, said lid including: a sealant layer; a biaxially-oriented film; and a metallic foil layer having a thickness not greater than 0.0005 inches, where the metallic foil layer is adhered to one side of the biaxially-oriented film, and the sealant layer is applied to an opposite side of the biaxially-oriented film such that the sealant layer is placed in contact with the container around the opening.

Also disclosed in embodiments herein is a method of forming a lidding material, comprising: extrusion laminating a biaxially-oriented film onto a metallic foil substrate, wherein the metallic foil substrate has a thickness not greater than 0.0005 inches, and where the metallic foil layer is adhered to one side of the biaxially-oriented film; and applying a sealant layer to an opposite side of the biaxially-oriented film.

### BRIEF DESCRIPTION OF THE DRAWINGS

FIG. 1 is a perspective view illustrating the layers of a lidding material in accordance with an embodiment disclosed herein;

FIG. 2 is an illustration of the disclosed lidding material on a container in accordance with an embodiment disclosed herein; and

FIG. 3 is a flowchart depicting a method of forming the lidding material.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

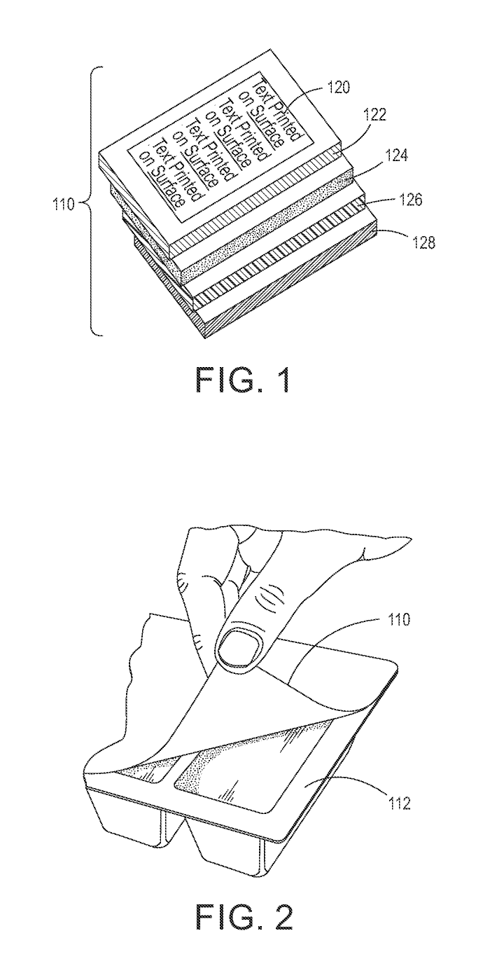

Referring to FIG. 1, the disclosed embodiment incorporates a biaxially-oriented film into the lamination of foil and the sealant film. Films of this type have good resistance to both puncture and tear initiation, and are employed, as illustrated in FIG. 2, to provide peelable lids or security covers 110 to foodstuffs and other perishable materials stored within a container 112. In some cases where a high gas permeability barrier is not required, foil has been eliminated entirely. However, in order to control curl, the thickness of the biaxially-oriented film needs to be increased beyond a thickness required to provide the requisite strength. As a result of the increased thickness of the biaxially-oriented layer, alone or in combination with the thinner foil layer or substrate, curl of the material is no more than 5%, as measured, for example, by the degrees the substrate is out of plane (e.g. TAPPI T-466—Degree of Curl and Sizing of Paper (ASTM D 826), which is hereby incorporated by reference). Accordingly, the biaxially-oriented layer is resistant to curling in its free state. Biaxial film is present to provide strength and balance the forces that can produce curl in the laminated lidding material. The maximum curl of the material is important as it avoids problems when such materials are used on converting equipment.

The disclosed embodiment employs an optimal thickness of the biaxially-oriented film to provide the required strength necessary for a lidding application as well as removal of the lid, while utilizing the minimum thickness of foil that meets the desired barrier to permeation. Additionally, positioning the biaxially-oriented film between the foil and the sealant presents a foil surface for embossing and reduces the likelihood that the total membrane structure will curl. The avoidance of curl in lids is important, particularly in relation to pick and place lidding applications where curl is potentially disruptive of the successive feeding or handling of precut lids.

As contemplated herein the biaxially-oriented film could be made of any polymeric material such as, but not limited to, polyester (e.g., polyethylene terephthalate (PET)), polypropylene (PP), polyamide (PA), polylactic acid (PLA), polyethylene (PE) or cellophane. As conceived, the biaxially-oriented film would be of the minimal thickness necessary to achieve the desired strength but would generally be expected to be in the range of 0.00035 in.-0.0015 in. As will be appreciated, the desired strength is at least a function of the container size, such that a lid spanning a larger container opening may need to have a greater strength than a lid spanning a smaller opening. The thickness of the aluminum foil substrate layer would be only what is necessary to provide the needed barrier to gas permeation and the depth of embossing but would generally be expected to be in the range of about 0.000235 in.-0.0007 in. and preferably less than about 0.0005 in.

The lamination of the biaxially-oriented film to the aluminum foil would be accomplished through conventional adhesive or extrusion laminating processes. As conceived, the disclosed embodiment would use conventional sealant processes and materials, either by direct coating of the biaxially-oriented film with a liquid or extruded thermosetting polymer, or by the lamination of a sealant film, by any conventional method, to the biaxially-oriented film.

Furthermore, the disclosed film structure does not only have to be in the configuration of foil-adhesive-biaxially-oriented film-sealant but may be of the configuration of biaxially-oriented film-adhesive-foil-sealant. And. Although described relative to an aluminum foil layer, it is possible that alternative barriers to permeability may be employed as well.

In one material structure, the lamination conditions or parameters, which may include winding, could change the material's properties in terms of curl and strength. To clarify, the lamination process, which includes the biaxially-oriented material, allows for down gauging of the foil thickness and also allows for use of the biaxially-oriented material but without a curl issue as would be the case if only biaxially-oriented material were used with an applied sealant as the lidding material. A feature of the disclosed embodiments is combining two dissimilar materials to optimize the functionality of each. For instance, the foil provides the barrier at a lower thickness than what is commonly used but, at a thin barrier-optimized thickness, is too weak to function as a lidding. The biaxially-oriented material, even as thin as 0.00032 in., is very strong but, when coated with a heat-sealable polymer, will curl up. In order to prevent curl, common practice is to use biaxially-oriented material that is 0.0015 in. to 0.002 in. thick. By laminating the foil and BOM together with an extruded layer of elastomeric polymer of a thickness of approximately 0.0005 in., the finished structure has a low tendency to curl.

In yet another embodiment, the material structure may be more specifically characterized by the layers set forth in the following table:

| Layer | FIG. 1 Descriptor | Composition |
|---|---|---|
| Top | Printing (optional); 120 | Ink |
| 1 | Aluminum Foil; 122 | 0.005″ Foil |
| 2 | Adhesive; 124 | 7# PE |
| 3 | Biax.-Oriented Film; 126 | 48 PET |
| 4 | Sealant; 128 | 14 to 18# Heat Seal Coating (HSC) |

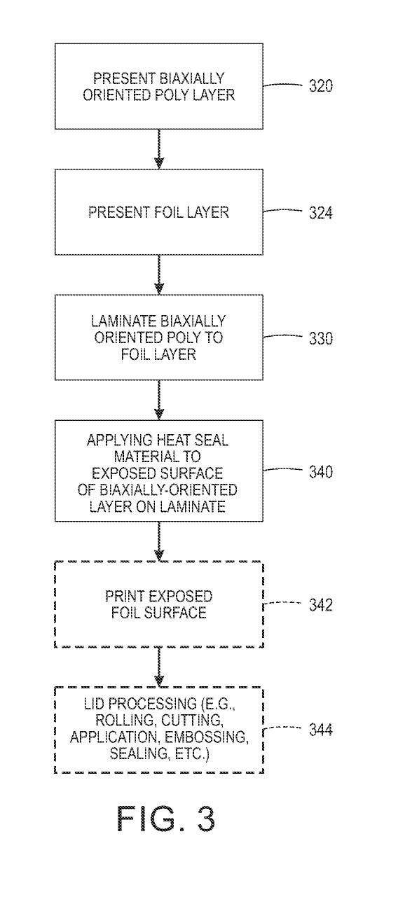

An exemplary method of manufacture of the various structures above would, as represented in FIG. 3, include forming the lidding structure using an adhesive, extrusion lamination or any similar process, where a biaxially oriented layer is presented at 320, and a foil layer is presented at 324, and the biaxially oriented layer is adhered to the foil layer at 330 using an adhesive or extrusion lamination operation to prepare a laminate. It will be understood that the biaxially oriented layer may be provided as a pre-manufactured film or may be extruded and oriented (worked) as part of the method of making the laminated lidding material. The biaxially oriented layer is adhered to the foil backing layer, the exposed polymer surface of the laminate and also has a heat seal coating (sealant) layer applied at 340. It will be further appreciated that various heat seal materials may be applied. In one embodiment, the heat sealant layer could be a solution-applied heat seal coating in the range of 2#/rm to 5#/rm. Moreover, depending upon the particular characteristics desired for the heat seal, and the packaging or tray/container to which the lid is to be applied, the heat seal material may be any number of polymers that would be sealable in response to an energy source such as that supplied via heat, ultrasonics, laser, or other means, applied to the lidding material to seal the lid to the tray. A polymer compatible with a tray/container could include polymers like a general polyolefin, polyethylene (PE), ethylene-vinyl acetate (EVA), bio-based polymers such as Poly (hydroxyalkanoates) (PHA), polylactides (PLA), co-polyesters, and the like.

Once the heat seal material has been applied the lidding material may then be rolled or otherwise further processed (342), including the application of coating(s) (e.g. printing) to the exposed surface of the foil layer (344), and where in use the completed lidding material is then placed over a container(s) and the application of an energy source (e.g. heat, laser, ultrasonics, etc.) around at least a top rim of the container causes the lidding material's heat seal coating to adhere to the rim of the container forming a seal between the lidding material and the container as depicted in FIG. 2.

In one application, the foil, biaxially-oriented material and sealant resins are laminated possibly in an inline extrusion-lamination process in order to optimize the combination of a thin foil film and the biaxially-oriented material.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A lidding material, comprising:
a sealant layer;
a biaxially-oriented film; and
a thin metallic foil layer where the metallic foil layer is adhered to one side of the biaxially-oriented film, and the sealant layer is applied to an opposite side of the biaxially-oriented film.

2. The lidding material according to claim 1, wherein the biaxially-oriented layer is formed from a material selected from the group consisting of: polyester, polypropylene, polyamide, polylactic acid, polyethylene and cellophane.

3. The lidding material according to claim 2, wherein the thickness of the biaxially-oriented layer is at least 0.00035 in.

4. The lidding material according to claim 1, wherein the biaxially-oriented layer is of a thickness such that it is resistant to damage from physical forces such as puncturing or tearing.

5. The lidding material according to claim 1, wherein the lidding material is precut to a shape suitable for sealing a container opening.

6. The lidding material according to claim 3, wherein the thickness of the metallic foil layer is not greater than 0.0007 in.

7. The lidding material according to claim 6, wherein the thickness of the metallic foil layer is not greater than 0.0005 in.

8. The lidding material according to claim 6, wherein the sealant layer includes a material selected from the group consisting of: a solution-applied heat seal coating, polyolefin, polyethylene, ethylene-vinyl acetate, bio-based polymer, Poly (hydroxyalkanoates), polylactides, and co-polyesters.

9. The lidding material according to claim 1, wherein the material exhibits a curl of no more than 5 percent, as measured by the degrees the substrate is out of plane.

10. A container comprising:
a lower portion having a recess therein and forming an opening; and
a lid, precut from a sheet and continuously sealed to the container around the opening, said lid including: a sealant layer; a biaxially-oriented film; and a thin metallic foil layer, where the metallic foil layer is adhered to one side of the biaxially-oriented film, and the sealant layer applied to an opposite side of the biaxially-oriented film is placed in contact with the container around the opening.

11. The container according to claim 10, wherein the biaxially-oriented layer is formed from a material selected from the group consisting of: polyester, polypropylene, polyamide, polylactic acid, polyethylene and cellophane.

12. The container according to claim 11, wherein the thickness of the biaxially-oriented layer in said lid is at least 0.00035 in.

13. The container according to claim 12, wherein the thickness of the metallic foil layer in said lid is not greater than 0.0007 in.

14. The container according to claim 10, wherein the biaxially-oriented layer in said lid is of a thickness adequate to resist curling in a free state.

15. A method of forming a lidding material, comprising:
affixing a biaxially-oriented film to a thin metallic foil substrate, where the thin metallic foil layer is adhered to a first side of the biaxially-oriented film; and
applying a sealant layer to an opposite, second side of the biaxially-oriented film.

16. The method according to claim 15, wherein the biaxially-oriented film is formed from a material selected from the group consisting of: polyester, polypropylene, polyamide, polylactic acid, polyethylene and cellophane.

17. The method according to claim 16, wherein the thickness of the biaxially-oriented film is at least 0.00035 in.

18. The method according to claim 15, wherein the biaxially-oriented layer is of a thickness such that it is resistant to damage from physical forces such as puncturing or tearing.

19. The method according to claim 15, wherein the lidding material is precut to a shape suitable for sealing a container opening.

20. The method according to claim 15, wherein the material exhibits a curl of no more than 5 percent, as measured by the degrees the substrate is out of plane.
